(19) United States
(12) Patent Application Publication
(10) Pub. No.: US 2017/0344988 A1
(43) Pub. Date: Nov. 30, 2017

(54) SYSTEM AND METHOD FOR FACILITATING BLOCKCHAIN-BASED VALIDATION

(71) Applicant: UBS AG, Zurich (CH)

(72) Inventors: Ian CUSDEN, St. Mary's Island (GB); Joseph GOULDEN, Isle of Dogs (GB); Alex BATLIN, Parklands (GB)

(21) Appl. No.: 15/163,306

(22) Filed: May 24, 2016

(51) Int. Cl. G06Q 20/40; H04L 29/12; H04L 9/32; H04L 9/14; G06F 17/30; H04L 9/08; G06Q 50/18; G06Q 20/38; H04L 29/06; H04L 9/30

(52) U.S. Cl. CPC G06Q 20/401; H04L 63/06; H04L 61/2038; H04L 9/3247; H04L 9/30; G06F 17/30867; H04L 9/0861; G06Q 50/18; G06Q 20/3829; H04L 9/14

(57) ABSTRACT

In certain embodiments, blockchain-based validation of a bearer of a private key used to register a record on a blockchain may be facilitated. In some embodiments, reference information associated with a user and with a blockchain record may be obtained. The reference information may be based on a blockchain address associated with the user and with the record. The blockchain address may be based on a public key corresponding to a private key used to register the record, where the keys are a key pair associated with the user. A smart contract may be caused to be generated based on the reference information and provided on a blockchain. The smart contract may be configured to automatically validate a transaction using the public key. A notification indicating that the user registered the record may be obtained responsive to the smart contract validating a transaction signed using the private key.

### FIELD OF THE INVENTION

The invention relates to blockchain-based validation, including, for example, blockchain-based validation of a bearer of a private key used to register a record on a blockchain.

### BACKGROUND OF THE INVENTION

Blockchain technology can provide a “distributed ledger,” or a database maintained not by a single actor, such as a bank, but collaboratively by a number of participants. As an example, blockchain-based techniques include multiple participant computer systems regularly agreeing on how to modify the database, after which the modifications they have settled on are rendered unchangeable with the help of complex cryptography. The blockchain can further serve as the underpinning for “smart contracts” which, via its computer protocols, are capable of automatically enforcing themselves using their respective programmed rules to process information taken as input and to take required actions.

Although a number of non-blockchain-based technologies related to account and data security, authentication, and verification exist (e.g., authorization/access to financial or other accounts, verification of buyers of purchase transactions, verification of owners of securities, verification of notaries of documents, etc.), many of these technologies rely on trust of the third party managing the database and/or lack one or more benefits of blockchain technology.

### SUMMARY OF THE INVENTION

Aspects of the invention relate to methods, apparatuses, and/or systems for facilitating blockchain-based validation. In certain embodiments, blockchain-based validation of a bearer of a private key used to register a record (e.g., a transaction or other record) on a blockchain may be facilitated. In some embodiments, one or more smart contracts may be provided on a blockchain and configured to perform one or more operations to facilitate blockchain-based validation. As an example, a smart contract is a computer application programmed to process one or more transactions that are sent to the computer application and provide one or more results or take one or more actions therefrom. In some cases, a smart contract is configured to automatically validate one or more transactions by: (i) using one or more public keys of public/private key pairs to ensure that the transactions are respectively signed using the corresponding private keys; (ii) processing the transactions to ensure that the transaction are sent from the appropriate entities (e.g., intended recipients of a challenge); or (iii) performing one or more other operations as described herein.

In some embodiments, a computer system may be programmed to: obtain reference information associated with a user, wherein the reference information may include a blockchain address associated with the user and with a blockchain record, and the blockchain address is based on a public key corresponding to a private key that was used to register the record, the public key and the private key being a public/private key pair associated with the user; cause a smart contract to be generated based on the reference information and to be provided on a blockchain, wherein the smart contract is configured to automatically validate a transaction using the public key associated with the user; and obtain a notification indicating that the user registered the record, wherein the notification is generated via the smart contract responsive to the smart contract validating a transaction signed using the private key associated with the user.

In some embodiments, a computer system may be programmed to: cause a first transaction to be generated based on a private key of a public/private key pair associated with a user that was used to register a record on a blockchain; provide the first transaction to be validated by a smart contract on a blockchain, wherein the smart contract is configured to automatically validate a transaction using a public key of the public/private key pair associated with the user; and obtain a notification indicating that the user registered the record, wherein the notification is generated via the smart contract responsive to the smart contract validating the first transaction as a transaction signed using the private key associated with the user.

Various other aspects, features, and advantages of the invention will be apparent through the detailed description of the invention and the drawings attached hereto. It is also to be understood that both the foregoing general description and the following detailed description are exemplary and not restrictive of the scope of the invention. As used in the specification and in the claims, the singular forms of “a”, “an”, and “the” include plural referents unless the context clearly dictates otherwise. In addition, as used in the specification and the claims, the term “or” means “and/or” unless the context clearly dictates otherwise.

### BRIEF DESCRIPTION OF THE DRAWINGS

FIG. 1 shows a system for facilitating blockchain-based validation, in accordance with one or more embodiments.

FIG. 2 shows a diagram of a use case in which a user is validated, via one or more smart contracts, as a bearer of a private key used to register a record on a blockchain, in accordance with one or more embodiments.

FIG. 3 shows a flowchart of a method of performing validation of a user as a bearer of a private key used to register a record, in accordance with one or more embodiments.

FIG. 4 shows a flowchart of a method of responding to a validation challenge to validate a user as a bearer of a private key used to register a record, in accordance with one or more embodiments.

### DETAILED DESCRIPTION OF THE INVENTION

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other instances, well-known structures and devices are shown in block diagram form in order to avoid unnecessarily obscuring the embodiments of the invention.

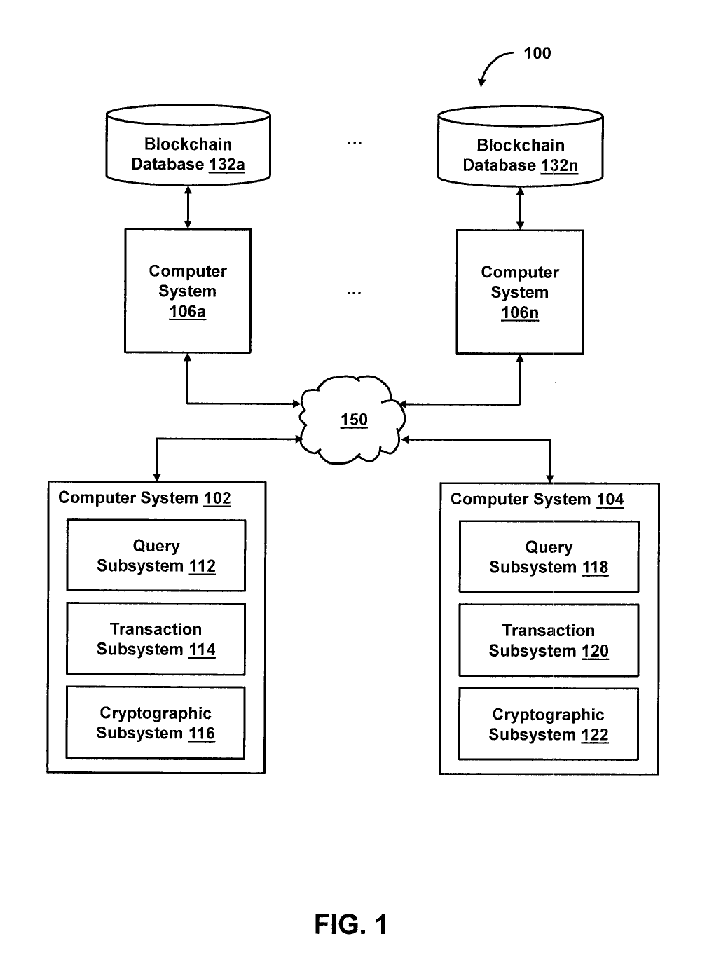

FIG. 1 shows a system 100 for facilitating blockchain-based validation, in accordance with one or more embodiments. As shown in FIG. 1, system 100 may include computer system 102, computer system 104, computer system 106 (or computer systems 106a-106n), or other components. In some embodiments, computer system 102 and computer system 104 may each be a user device. Each of the user devices may include any type of mobile terminal, fixed terminal, or other device. By way of example, a user device may include a desktop computer, a notebook computer, a tablet computer, a smartphone, a wearable device, or other user device. Users may, for instance, utilize one or more user devices to interact with one another, one or more servers, or other components of system 100. In some embodiments, computer system 102 and/or computer system 104 may be one or more servers or other components. Computer system 106 may include one or more servers, user devices, or other components.

Computer system 102 may include query subsystem 112, transaction subsystem 114, cryptographic subsystem 116, or other components. Computer system 104 may include query subsystem 118, transaction subsystem 120, cryptographic subsystem 122, or other components. It should be noted that, while one or more operations are described herein as being performed by particular components of computer system 102, computer system 104, or computer system 106, those operations may, in some embodiments, be performed by other components of such computer systems or other components of system 100. As an example, while one or more operations are described herein as being performed by components of computer system 102, those operations may, in some embodiments, be performed by components of computer system 104 or other components of system 100 (or vice versa).

Blockchain-Based Validation Via a Smart Contract

In some embodiments, a smart contract may be generated and provided on a blockchain such that it is configured to automatically validate blockchain transactions to facilitate blockchain-based validation of whether a user registered (or its user account was used to register) a blockchain record (e.g., a blockchain transaction or other record). As an example, a user that is challenged to prove that it registered a particular record on a blockchain may respond to the challenge by generating a new transaction, signing the transaction with the private key used to previously sign the blockchain record, and sending the signed transaction (e.g., including the transaction, a digital signature generated based on the transaction and the private key, and/or other data) to the smart contract. Upon receipt, the smart contact may use the public key (of the same public/private key pair as the private key) to validate the signed transaction. In one use case, for example, responsive to confirming that the transaction was signed with the private key (used to previously sign the particular blockchain record) or one or more other particular validation results (e.g., as described herein), the smart contract may cause the user or others to be notified with respect to the confirmed validity of the transaction (e.g., indicating that the user registered the blockchain record or other indications). In some embodiments, the record (for which related proof is sought) may be registered on the same blockchain as the smart contract. In some embodiments, the record may be registered on a blockchain different from the blockchain on which the smart contract is provided.

In some embodiments, a blockchain record may be associated with a real-world account (e.g., financial or other account), a real-world transaction, or other asset or activity (e.g., other real-world or non-real-world asset or activity). A smart contract may be generated and provided on a blockchain to facilitate blockchain-based validation of whether a user (or its blockchain user account) is: (i) an authorized owner or user of a real-world account or other asset; (ii) a party or other entity with respect to a real-world transaction or other activity (e.g., a buyer or seller in a consumer purchase transaction, a signing witness to a transaction, etc.); (iii) a notary of a document; or (iv) other entity in accordance with one or more techniques described herein.

In some embodiments, computer system 102 (e.g., via query subsystem 112) may obtain reference information associated with a user. As an example, the reference information may be obtained and utilized to issue a challenge to the user. In one use case, the reference information may be utilized to generate a challenge to the user to prove that the user is a bearer of a private key used to register a record on a blockchain (e.g., a registered transaction or other record), and the obtained reference information may be associated with the user (or account thereof) and with the record. As an example, the reference information may include a blockchain address associated with the user and/or with the record. The blockchain address may be based on a private key of a public/private key pair associated with the user that was used to register the record, a public key of the public/private key pair, or other data. In one use case, the private key may be utilized to generate the public key, and the public key may be utilized to generate the blockchain address. In some use cases, multiple blockchain address may ultimately be derived from the same private key. As such, for instance, multiple blockchain addresses may be associated with the bearer (or its user account) of that same private key.

The reference information may include a blockchain address associated with the user and/or with the record, the public key (corresponding to the private key used to register the record), a blockchain address of a smart contract configured to operate on behalf of the user on a blockchain, an alias of the user, or other information. As an example, one or more of the foregoing items of the reference information may be obtained or determined from the record, sources on the blockchain, or other sources. In one scenario, for instance, computer system 102 may obtain a blockchain address associated with the user and with the record by extracting the “from” address of the record from the record to obtain the blockchain address (associated with the user and with the record).

In some embodiments, computer system 102 (e.g., via transaction subsystem 114) may cause a smart contract to be generated based on the reference information and to be provided on a blockchain. As an example, the smart contact may be generated such that the smart contract is configured to perform automatic validation of whether a given user is a bearer of a private key used to register the record. In one use case, the smart contract may be configured to perform the automatic validation by using a public key (corresponding to the private key used to register the record) to validate signed transactions. In some cases, the smart contract may be generated to include or have access to one or more items of the reference information, such as the blockchain address associated with the user and/or the record, the corresponding public key, or other data (e.g., a blockchain address of a smart contract configured to operate on behalf of the user on a blockchain, an alias of the user, etc.). If, for example, a transaction (provided responsive to a challenge to a given user) is signed using the corresponding private key (e.g., a signed transaction provided by the computer system 104 associated with the given user), the public key can be used to confirm that the given user holds the private key used to register the record. As an example, the public key and the private key may be a public/private key pair with respect to a cryptographic scheme, where the private key (which is kept private) may be used to generate a digital signature, and the public key (which may be publically known and available) may be used to verify that the private key was used to generate the digital signature.

In some embodiments, computer system 102 (e.g., via transaction subsystem 114) may provide a request to computer system 106 (or at least one of the computer system 106a-106n) to generate the smart contract (e.g., a request to initiate a challenge to a given user to prove that the user is the bearer of the private key used to registered the record) and provide the generated smart contract on the blockchain. In some embodiments, the request may be based on reference information associated with the intended recipient of the challenge, such as an alias of the intended recipient, a blockchain address associated with the intended recipient (e.g., an address associated with the intended recipient and with the blockchain record), or other data (e.g., a secret, a salt, a hash of the secret and/or the salt, or other data as described herein). Computer system 106 may generate the smart contract based on the request such that the smart contract includes code to access the blockchain address associated with the intended recipient or other data (e.g., the secret, the salt, the hash of the secret and/or the salt, etc.) (and/or one or more of the data themselves) and provide the smart contract on the blockchain. In some embodiments, the generated smart contract includes the blockchain address associated with the intended recipient or the other data.

In some embodiments, to respond to the smart contract provided on the blockchain, computer system 104 (e.g., via transaction subsystem 120) may cause a transaction to be generated based on the private key (of the public/private key pair associated with the user) that was used to register the blockchain record. As an example, computer system 104 (e.g., via cryptographic subsystem 122) may sign the transaction using the same private key used to sign the record. The signed transaction may be provided to the smart contract on the blockchain to be validated, for example, to prove that computer system 104 (or its user) is a bearer of the private key used to sign the record. Upon receipt of the signed transaction, the smart contract may automatically validate the signed transaction using the public key (corresponding to the private key used to sign the record). The public key may, for example, be utilized to verify that the signed transaction was signed with the same private key used to sign the blockchain record. In another scenario, however, if a different key was used to sign the first transaction and then provided to the smart contract for automatic validation, the smart contract returns an indication that computer system 104 (or its user) is not a bearer of the private key used to sign the record.

In some embodiments, the smart contract may be generated such that the smart contract is configured to include encrypted information (e.g., an encrypted version of a secret, a salt, a hash of the secret and/or the salt, or other data) that is encrypted using the public key (corresponding to the private key used to sign the record for which related proof is being sought). The information may be encrypted based on one or more cryptographic schemes and the public key such that the corresponding private key is needed to decrypt the information. In one use case, the information in the smart contract may be encrypted and provided for inclusion in the smart contract (e.g., by computer system 102, computer system 106, etc.). In another use case, the smart contract may be generated such that the smart contract is configured to automatically generate the information (e.g., random data or other data) and/or encrypt the information using the public key. In some embodiments, the decrypted version of the encrypted information may be necessary to generate a transaction that would be deemed by the smart contract to be a valid response to a particular challenge. As an example, a user may additionally or alternatively prove that it is the bearer of the private key used to sign the record by using the private key to decrypt the encrypted information and using the information to provide a valid response to the challenge (e.g., by including the information in the transaction, using the information as input to one or more functions and providing the output in the transaction, etc.). As a further example, upon receipt of the “response” transaction, the smart contract may determine that the transaction is valid (e.g., indicating that the user is the bearer of the private key) responsive to the transaction including the information, the function output, or an otherwise valid response expected from the bearer of the private key.

In some embodiments, computer systems 102 and/or 104 (e.g., via their query subsystems 112 and 118) may obtain a notification indicating that the user registered the record (e.g., for which related proof is sought). As an example, the notification may be generated via the smart contract and/or provided to computer systems 102 and/or 104 responsive to the smart contract validating the transaction (e.g., confirming that the transaction was signed using the private key).

Validation of Challenge Response as being from Intended Challenge Recipient

In some embodiments, computer system 102 (e.g., via transaction subsystem 114) may obtain a secret and cause the smart contract to be generated based on the secret and/or other data. In some embodiments, computer system 102 may cause the smart contract to be generated such that the smart contract includes a hash of the secret and/or other data (e.g., a salt or other random data) and is configured to automatically validate a transaction by using the public key (corresponding to the private key used to register the record) and the hash of the secret and/or other data. As an example, the smart contract may verify that the intended recipient of a challenge (provided via the smart contract) is the one signing the transaction by verifying that the signed transaction includes the secret using the public key and the hash of the secret and/or other data.

In some embodiments, computer system 102 (e.g., via cryptographic subsystem 116) may combine the secret and the salt to generate a first hash input and hash the first hash input to generate a first hash output. In one scenario, computer system 102 (e.g., via transaction subsystem 114) may provide the first hash output as at least part of a request to initiate a challenge to a given user (e.g., where the smart contract generated based thereon includes the first hash output). In another scenario, computer system 102 may hash the first hash output to generate a second hash output (a “double hash”) and provide the second hash output as at least part of a request to initiate a challenge to a given user (e.g., where the smart contract generated based thereon includes the second hash output).

In some embodiments, computer system 102 (e.g., via transaction subsystem 114) may provide the challenge request to computer system 106 (or at least one of the computer system 106a-106n) to generate a challenge contract (e.g., the smart contract generated to include the first/second hash output and/or other data). In some embodiments, the challenge request may be based on reference information associated with the intended recipient of the challenge. As an example, the reference information may include (i) a blockchain address associated with the record (for which related proof is sought) and with the blockchain user/account that registered the record, (ii) the public key (corresponding to the private key used to register the record for which related proof is sought), (iii) a blockchain address of a smart contract configured to operate on behalf of the intended recipient on a blockchain, (iv) an alias of the intended recipient, (v) a hash of the secret and the salt (e.g., the first/second hash output), (vi) the salt, or (vii) other data. The challenge request may be generated based on the reference information to include one or more of the foregoing items of the reference information. Computer system 106 may generate the challenge contract in the form of a smart contract based on the challenge request such that the challenge contract includes code to access (i) the blockchain address associated with the record (and with the user/account that registered the record), (ii) the salt, (iii) the hash of the secret and the salt, (iv) or other data and provide the challenge contract on a blockchain. In some embodiments, the generated smart contract may include (i) the blockchain address associated with the record, (ii) the salt, (iii) the hash of the secret and the salt, or (iv) the other data. In some embodiments, the smart contract may include an encrypted version of (i) the blockchain address associated with the record, (ii) the salt, (iii) the hash of the secret and the salt, or (iv) the other data, where the foregoing item(s) included in the smart contract is encrypted based on the public key (corresponding to the private key used to register the record), as described herein (e.g., such that the private key is needed to decrypt and read the items in the smart contract).

In some embodiments, computer system 104 may respond to the challenge contract by causing a first transaction to be generated based on the private key (of the public/private key pair associated with the user) and at least one of the secret, the salt, or other data. In some embodiments, computer system 104 (e.g., via cryptographic subsystem 122) may obtain the secret via one or more techniques (e.g., from computer system 102, from a user thereof who receives the secret via email, phone, etc., from another user or other system, or other source). Computer system 104 (e.g., via transaction subsystem 120) may generate the first transaction by including the secret and signing the first transaction with the private key and send the signed transaction to the smart contract for validation (e.g., via computer system 106). The smart contract (e.g., via computer system 106) may use the public key (corresponding to the private key) to verify whether the first transaction was signed using the private key. Additionally, or alternatively, the smart contract may hash the secret read from the first transaction to generate a first hash output and compare the first hash output with the smart contract's stored hash of the secret. Responsive to confirming that the private key was used to sign the first transaction, that the first hash output matches the stored hash, or one or more other results, the smart contract may indicate that the first transaction is valid (e.g., indicating that the intended recipient of the challenge is the bearer of the private key, that the first transaction was received from the intended recipient, etc.).

In some embodiments, computer system 104 (e.g., via cryptographic subsystem 122) may obtain the salt via one or more techniques (e.g., from the challenge contract, from computer system 102, from a user thereof who receives the salt via email, phone, etc., from another user or other system, or other source). Computer system 104 (e.g., via cryptographic subsystem 122) may combine the secret and the salt, and hash the secret-salt combination to generate a first hash output. Computer system 104 (e.g., via transaction subsystem 120) may generate the first transaction by including the first hash output and signing the first transaction with the private key and send the signed transaction to the smart contract for validation. The smart contract may use the public key (corresponding to the private key) to verify whether the first transaction was signed using the private key. Additionally, or alternatively, the smart contract may hash the first hash output read from the first transaction to generate a second hash output and compare the second hash output with the smart contract's stored hash of the secret-salt combination (e.g., a “double hash” of the secret-salt combination). Responsive to confirming that the private key was used to sign the first transaction, that the first hash output matches the stored hash, or one or more other results, the smart contract may indicate that the first transaction is valid.

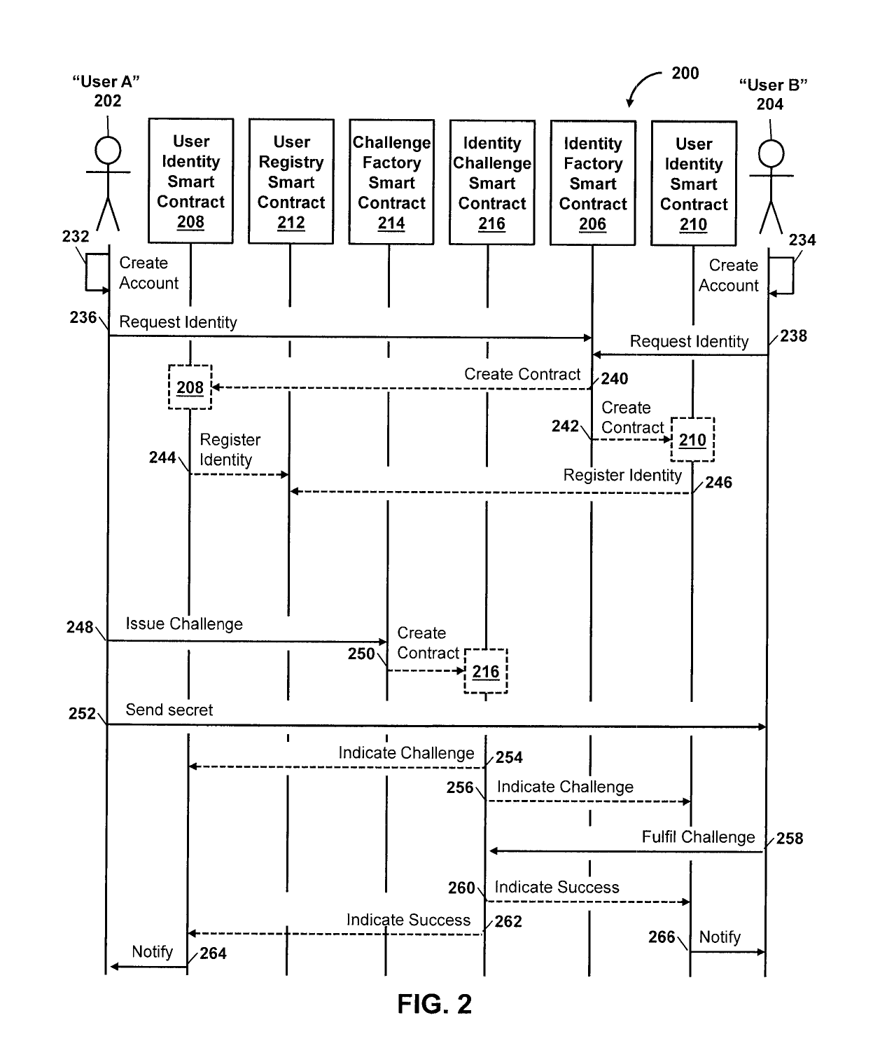

FIG. 2 shows a diagram 200 of a use case in which a user is validated, via one or more smart contracts, as a bearer of a private key used to register a record on a blockchain, in accordance with one or more embodiments. As shown in FIG. 2, some embodiments may enable a blockchain user (e.g., user 202, also referred to as “User A”) to verify that another blockchain user (user 204, also referred to as “User B”) is (i) the holder of a private key (in a given key pair) used to sign one or more blockchain records (e.g., transactions or other records) and (ii) the entity to which User A has communicated a “secret,” for example, to ensure that only User B can provide a satisfactory response, as described herein. It should be noted that, when referring to a user (e.g., User A, User B, etc.) “doing X,” it is contemplated that one or more applications or other components of a user device of the respective user may be performing the relevant operations to “do X.” In some embodiments, computer system 102 may be a user device that performs one or more operations described herein with respect to User A. In some embodiments, computer system 104 may be a user device that performs one or more operations described herein with respect to User B.

In some embodiments, User B may be a customer and may have purchased an item from a merchant online via one or more blockchain-based techniques in which User B signed the purchase transaction with User B's private key. Upon delivery of the item, User A (or a delivery or other agent of User A) may ask for verification from User B to demonstrate that User B is the purchaser, such as requiring User B to be the holder of the private key used for the purchase transaction, to have a “secret” which User A communicated to the purchaser, etc. This, for example, enables User A to be confident that the item has been delivered, in the real world, to the correct person. In some embodiments, User B may be an account owner (e.g., a safe deposit account or other account), and User B may have previously signed a blockchain transaction, indicating opening of the account, with User B's private key. As an example, if the account corresponds to a safe deposit at a bank and User B arrives at the bank to access his/her safe deposit, User A (an agent of the bank) may ask for verification from User B to demonstrate that User B is the account owner, such as requiring User B to be the holder of the private key used for the blockchain transaction (e.g., indicating opening of the account), to have a “secret” which User A communicated to the account owner, etc. Other embodiments with regard to other applications in accordance with one or more techniques described herein are further contemplated.

As shown in FIG. 2, some embodiments may involve users and smart contracts (e.g., smart contracts 206-216 or other smart contracts) on a blockchain (or different blockchains) interacting with one another. In some embodiments, at operations 232 and 234, Users A and B may each generate a public/private key pair and a blockchain account associated with the public/private key pair. As an example, in the ETHEREUM environment or other environments, generation of a blockchain may include creating a new file that includes (i) the public key of the public/private key pair, (ii) the private key of the public/private key pair, (ii) a key generation algorithm (or a reference thereto), (iv) a salt or other entropy-ensuring number, (v) a blockchain address, or (vi) other data.

In some embodiments, at operations 236 and 238, Users A and B may each provide a request for a user identity smart contract on the blockchain network by sending a blockchain transaction (using the blockchain account) to identity factory smart contract 206. As an example, in the ETHEREUM environment or other environments, a blockchain account alone may not be able to respond to transactions or associate metadata. Such operations may, for example, be performed by an associated user identity smart contract which may be stored on a blockchain. For example, a user's respective user identity smart contract may “act” as the user's digital avatar on the blockchain in question.

At operations 240 and 242, responsive to each request for a user identity smart contract, identity factory smart contract 206 may generate user identity smart contract 208 (associated with User A's account) and user identity smart contract 210 (associated with User B's account). User identity smart contracts 208 and 210 may each be generated to include the blockchain address of the respective user's account and be configured to receive and respond to instructions, notifications, or other messages from one or more other smart contracts.

At operations 244 and 246, each of the blockchain addresses of user identity smart contracts 208 and 210 may be registered, together with an alias provided their respective users or other data (e.g., an alias of “Alice” for User A, an alias of “Bob” for User B, or other alias or data), in user registry smart contract 212. In some use cases, user registry smart contract 212 may be a definitive registry where user identity smart contract addresses (along with other data related to the respective users) may be stored.

In some embodiments, User A may issue a challenge for User B to prove that it (i) holds the private key used to sign a blockchain record and (ii) is the entity to which User A has communicated a “secret.” As an example, if User B's account was used to send and sign the record, the record may be associated with a blockchain address of User B's account (which is ultimately derived from User B's private key). The record may, for instance, include or otherwise be associated with the blockchain address of User B's account (e.g., as a “from” address in the record).

At operations 248 and 250, User A may provide a request to issue a challenge to User B in the form of a blockchain transaction to challenge factory smart contract 214 to cause an identity challenge smart contract to be generated, and, responsive to the challenge request, challenge factory smart contract 214 may generate identity challenge smart contract 216. At operation 252, User A may provide the secret to User B (e.g., via an off-blockchain communication channel, such as a phone call, email, mobile app, etc., or other communication channel), where the secret is needed for User B to fulfil the identity challenge. In some embodiments, a unique “secret” may be used for each identity challenge, for example, to enhance security. In some embodiments, the same “secret” may be used for multiple identity challenges.

In some embodiments, the challenge request may include (i) the blockchain address of User A's user identity smart contract 208, (ii) the blockchain address of User B's user identity smart contract 210, (iii) the blockchain address associated with the record and with the user (e.g., which may be the same as a blockchain address of User B's account); (iv) a “double hash” of a combination of the secret and a salt, (v) the salt, or (vii) other data (e.g., an alias for User A, an alias for User B, etc.). Challenge factory smart contract 214 may generate identity challenge smart contract 216 based on one or more of the foregoing items in the challenge request such that identity challenge smart contract 216 is configured to (i) generate a notification to Users A and B's respective user identity smart contracts 208 and 210 to inform of the identity challenge issued by User A against User B (e.g., operations 254 and 256) and (ii) automatically validate a transaction provided responsive to the identity challenge (e.g., by performing validation as described herein).

In some embodiments, User A may be informed of the identity challenge via an off-blockchain communication channel, such as a phone call, email, mobile app, etc., or other communication channel. As an example, a mobile application of User A's user device may read the notification communicated to User B's user identity smart contract 210.

At operation 258, User B may fulfil the identity challenge. As an example, identity challenge smart contract 216 may be generated to include the salt, and User B may read the salt from identity challenge smart contract 216, combine the secret (e.g., obtained from User A) and the salt, and hash the combination of the secret and the salt to generate a first hash output. User B may use its account to include the first hash output (and/or with other data) in a blockchain transaction, sign the transaction with its private key, and send the signed transaction to identity challenge smart contract 216.

In some embodiments, responsive to obtaining the signed transaction, identity challenge smart contract 216 may automatically validate the signed transaction. Because the public key (corresponding to the private key used to sign the record for which related proof is sought) is known, identity challenge smart contract 216 may use the corresponding public key to verify that the signed transaction was also signed using the same private key. Additionally, or alternatively, identity challenge smart contract 216 may hash the first hash output (in the signed transaction) to generate a second hash output and compare the second hash output to the double hash (e.g., the double hash in identity challenge smart contract 216, in the challenge request on which generation of identity challenge smart contract 216 was based, etc.). Additionally, or alternatively, identity challenge smart contract 216 may compare the “from” address of the signed transaction to the blockchain address associated with the record (for which related proof is sought) (e.g., if User B sends the signed transaction from this blockchain address, the “from” address will match).

At operations 260 and 262, identity challenge smart contract 216 may indicate that User B is the holder of the private key used to sign the record responsive to determining that the signed transaction was signed using the same private key and/or that the “from” address of the signed transaction matches the blockchain address associated with the record (for which related proof is sought). Additionally, or alternatively, identity challenge smart contract 216 may indicate that the transaction was sent by the entity to which User A has communicated the secret responsive to the generated second hash output matching the double hash.

Example Flowcharts

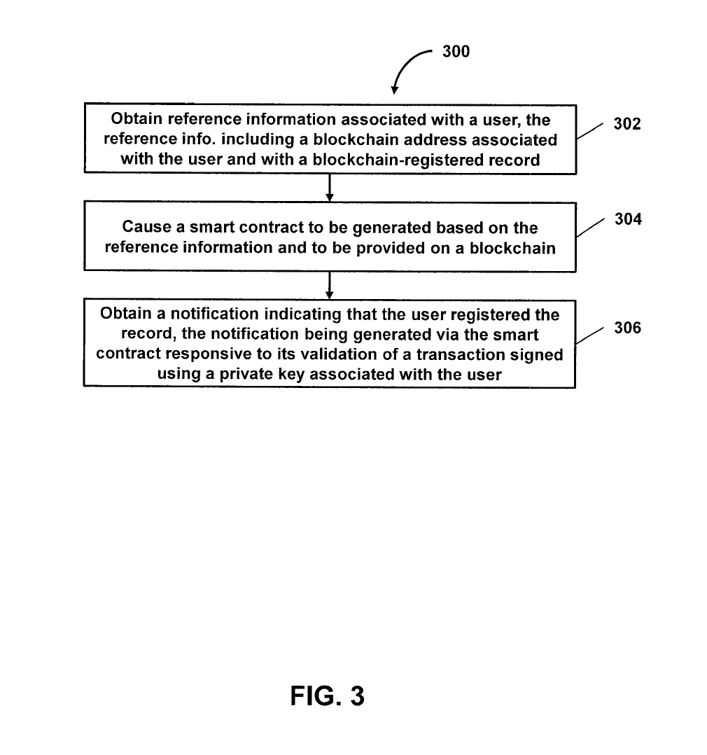

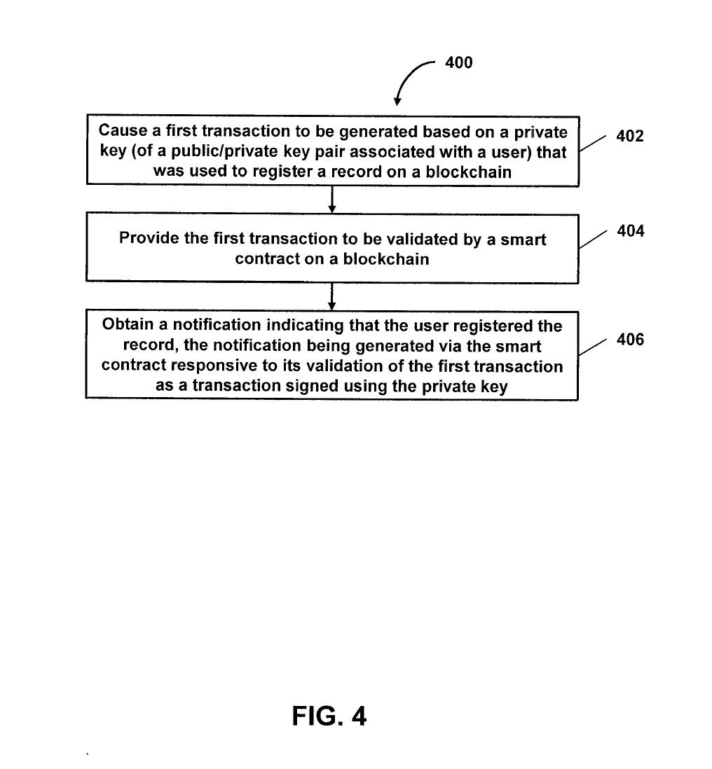

FIGS. 3-4 are example flowcharts of processing operations of methods that enable the various features and functionality of the system as described in detail above. The processing operations of each method presented below are intended to be illustrative and non-limiting. In some embodiments, for example, the methods may be accomplished with one or more additional operations not described, and/or without one or more of the operations discussed. Additionally, the order in which the processing operations of the methods are illustrated (and described below) is not intended to be limiting.

In some embodiments, the methods may be implemented in one or more processing devices (e.g., a digital processor, an analog processor, a digital circuit designed to process information, an analog circuit designed to process information, a state machine, and/or other mechanisms for electronically processing information). The processing devices may include one or more devices executing some or all of the operations of the methods in response to instructions stored electronically on an electronic storage medium. The processing devices may include one or more devices configured through hardware, firmware, and/or software to be specifically designed for execution of one or more of the operations of the methods.

FIG. 3 shows a flowchart of a method 300 of performing validation of a user as a bearer of a private key used to register a record, in accordance with one or more embodiments.

In an operation 302, reference information associated with a user may be obtained. As an example, the reference information may include a blockchain address associated with the user and with a blockchain record. The blockchain address may be based on a private key of a public/private key pair associated with the user that was used to register the record, a public key of the public/private key pair, or other data. In one use case, the private key may be utilized to generate the public key, and the public key may be utilized to generate the blockchain address. Operation 302 may be performed by a query subsystem that is the same as or similar to query subsystem 112, in accordance with one or more embodiments.

In an operation 304, a smart contract may be caused to be generated based on the reference information and provided on a blockchain. As an example, the smart contact may be generated such that the smart contract is configured to perform automatic validation of whether a given user is a bearer of a private key used to register the blockchain record. In one use case, the smart contract may be configured to perform the automatic validation by using a public key (corresponding to the private key used to register the record) to validate signed transactions. If, for example, a transaction provided responsive to a challenge to a given user is signed using the corresponding private key, the public key can be used to confirm that the given user holds the private key used to register the blockchain record. Operation 304 may be performed by a transaction subsystem that is the same as or similar to transaction subsystem 114, in accordance with one or more embodiments.

In an operation 306, a notification indicating that the user registered the record may be obtained. As an example, the notification may be generated via the smart contract responsive to the smart contract validating a transaction signed using the corresponding private key (e.g., the private key of the same public/private key pair as the public key used by the smart contract to validate the signed transaction). Operation 306 may be performed by a query subsystem that is the same as or similar to query subsystem 112, in accordance with one or more embodiments.

FIG. 4 shows a flowchart of a method 400 of responding to a validation challenge to validate a user as a bearer of a private key used to register a record, in accordance with one or more embodiments.

In an operation 402, a first transaction may be caused to be generated based on a private key (of a public/private key pair associated with a user) that was used to register a record on a blockchain. As an example, the first transaction may be generated by a device of the user responsive to a challenge being sent to the device (e.g., a challenge to prove that the user is the bearer of the private key used to register the record). Operation 402 may be performed by a transaction subsystem that is the same as or similar to transaction subsystem 120, in accordance with one or more embodiments.

In an operation 404, the first transaction may be provided to be validated by a smart contract on a blockchain. As an example, the smart contract may be configured to automatically validate a transaction using a public key of the public/private key pair associated with the user. If, for example, the transaction is signed using the private key (used to register the record), the smart contract can use the public key (corresponding to the private key) to confirm that the transaction is valid and, thus, verify that the user is the bearer of the private key. Operation 404 may be performed by a transaction subsystem that is the same as or similar to transaction subsystem 120, in accordance with one or more embodiments.

In an operation 406, a notification indicating that the user registered the record may be obtained. As an example, the notification may be generated via the smart contract responsive to the smart contract validating a transaction signed using the corresponding private key (e.g., the private key of the same public/private key pair as the public key used to generate the blockchain address associated with the record). Operation 406 may be performed by a query subsystem that is the same as or similar to query subsystem 118, in accordance with one or more embodiments.

In some embodiments, the various computers and subsystems illustrated in FIG. 1 may include one or more computing devices that are programmed to perform the functions described herein. The computing devices may include one or more electronic storages (e.g., blockchain databases 132a-132n or other electric storages), one or more physical processors programmed with one or more computer program instructions, and/or other components. The computing devices may include communication lines or ports to enable the exchange of information with a network (e.g., network 150) or other computing platforms via wired or wireless techniques (e.g., Ethernet, fiber optics, coaxial cable, WiFi, Bluetooth, near field communication, or other technologies). The computing devices may include a plurality of hardware, software, and/or firmware components operating together. For example, the computing devices may be implemented by a cloud of computing platforms operating together as the computing devices.

The electronic storages may include non-transitory storage media that electronically stores information. The electronic storage media of the electronic storages may include one or both of system storage that is provided integrally (e.g., substantially non-removable) with servers or client computing platforms or removable storage that is removably connectable to the servers or client computing platforms via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storage may store software algorithms, information determined by the processors, information received from servers, information received from client computing platforms, or other information that enables the functionality as described herein.

The processors may be programmed to provide information processing capabilities in the computing devices. As such, the processors may include one or more of a digital processor, an analog processor, a digital circuit designed to process information, an analog circuit designed to process information, a state machine, and/or other mechanisms for electronically processing information. In some embodiments, the processors may include a plurality of processing units. These processing units may be physically located within the same device, or the processors may represent processing functionality of a plurality of devices operating in coordination. The processors may be programmed to execute computer program instructions to perform functions described herein of subsystems 112-122 or other subsystems. The processors may be programmed to execute computer program instructions by software; hardware; firmware; some combination of software, hardware, or firmware; and/or other mechanisms for configuring processing capabilities on the processors.

It should be appreciated that the description of the functionality provided by the different subsystems 112-122 described herein is for illustrative purposes, and is not intended to be limiting, as any of subsystems 112-122 may provide more or less functionality than is described. For example, one or more of subsystems 112-122 may be eliminated, and some or all of its functionality may be provided by other ones of subsystems 112-122. As another example, additional subsystems may be programmed to perform some or all of the functionality attributed herein to one of subsystems 112-122.

Although the present invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the scope of the appended claims. For example, it is to be understood that the present invention contemplates that, to the extent possible, one or more features of any embodiment can be combined with one or more features of any other embodiment.

What is claimed is:

1. A method of facilitating blockchain-based validation of a bearer of a private key used to register a blockchain record, the method being implemented by a computer system that comprises one or more processors executing computer program instructions which, when executed, perform the method, the method comprising:
obtaining reference information associated with a user, wherein the reference information comprises a blockchain address associated with the user and with a blockchain record, and the blockchain address is based on a public key corresponding to a private key that was used to register the record, the public key and the private key being a public/private key pair associated with the user;
causing a smart contract to be generated based on the reference information and to be provided on a blockchain, wherein the smart contract is configured to automatically validate a transaction using the public key associated with the user; and
obtaining a notification indicating that the user registered the record, wherein the notification is generated via the smart contract responsive to the smart contract validating a transaction signed using the private key associated with the user.

2. The method of claim 1, wherein the blockchain record is registered on the same blockchain on which the smart contract is provided.

3. The method of claim 1, wherein the blockchain record is registered on another blockchain that is different from the blockchain on which the smart contract is provided.

4. The method of claim 1, wherein the notification is generated via the smart contract responsive to the smart contract validating a first transaction provided by a device of the user as a transaction signed using the private key associated with the user.

5. The method of claim 1, wherein the reference information comprises (i) the blockchain address associated with the user and with the blockchain record and (ii) a blockchain address of another smart contract configured to operate on behalf of the user on the blockchain.

6. The method of claim 1, wherein the smart contract is generated such that the smart contract is configured to automatically validate a transaction by verifying that the transaction comprises the blockchain address associated with the user and with the blockchain record.

7. The method of claim 1, further comprising:
obtaining a secret and causing the smart contract to be generated to (i) comprise a hash of the secret and/or other data and (ii) be configured to automatically validate a transaction by using the hash of the secret and/or other data to verify whether the transaction is valid,
wherein the device of the user is configured to (i) cause a first transaction to be generated based on the private key associated with the user and at least one of the secret or the other data and (ii) provide the first transaction to be validated by the smart contract.

8. The method of claim 7, wherein the other data comprises a salt, and the hash of the secret and/or the other data is a hash of the secret and the salt, and wherein the device of the user is configured to cause the first transaction to be generated based on the private key associated with the user, the secret, and the salt.

9. The method of claim 8, wherein the secret-salt hash is a combination, of the secret and the salt, at least twice hashed.

10. A system comprising:
a computer system that comprises one or more processors programmed with computer program instructions which, when executed, cause the computer system to:
obtain reference information associated with a user and with a blockchain record, wherein the reference information comprises a blockchain address associated with the user and with the blockchain record, and the blockchain address is based on a public key corresponding to a private key that was used to register the record, the public key and the private key being a public/private key pair associated with the user;
cause a smart contract to be generated based on the reference information and to be provided on a blockchain, wherein the smart contract is configured to automatically validate a transaction using the public key associated with the user; and
obtain a notification indicating that the user registered the record, wherein the notification is generated via the smart contract responsive to the smart contract validating a transaction signed using the private key associated with the user.

11. A method of facilitating blockchain-based validation of a bearer of a private key used to register a blockchain record, the method being implemented by a computer system that comprises one or more processors executing computer program instructions which, when executed, perform the method, the method comprising:
causing a first transaction to be generated based on a private key of a public/private key pair associated with a user that was used to register a record on a blockchain;
providing the first transaction to be validated by a smart contract on a blockchain, wherein the smart contract is configured to automatically validate a transaction using a public key of the public/private key pair associated with the user; and
obtaining a notification indicating that the user registered the record, wherein the notification is generated via the smart contract responsive to the smart contract validating the first transaction as a transaction signed using the private key associated with the user.

12. The method of claim 1, wherein the record is registered on the same blockchain as the smart contract.

13. The method of claim 1, wherein the record is registered on another blockchain that is different from the blockchain that the smart contract is on.

14. The method of claim 11, wherein the smart contract is based on reference information associated with the user and with the blockchain record, and wherein the reference information comprises a blockchain address associated with the user and with the blockchain record, and the blockchain address is based on the public key associated with the user.

15. The method of claim 14, wherein the reference information comprises (i) the blockchain address associated with the user and with the blockchain record and (ii) a blockchain address of another smart contract configured to operate on behalf of the user on the blockchain.

16. The method of claim 14, wherein the smart contract is configured to automatically validate a transaction by verifying that the transaction comprises the blockchain address associated with the user and with the blockchain record.

17. The method of claim 11, further comprising:
obtaining a secret;
obtaining other data from the smart contract; and
causing the first transaction to be generated based on the private key associated with the user, the secret, and the other data,
wherein the smart contract comprises a hash of the secret and/or the other data and is configured to automatically validate a transaction using the hash of the secret to verify whether the transaction is valid.

18. The method of claim 17, wherein the other data comprises a salt, and the hash of the secret and/or the other data is a hash of the secret and the salt, and wherein the first transaction is caused to be generated based on the private key associated with the user, the secret, and the salt.

19. The method of claim 18, wherein the secret-salt hash is a combination, of the secret and the salt, at least twice hashed.

20. A system comprising:
a computer system that comprises one or more processors programmed with computer program instructions which, when executed, cause the computer system to:
cause a first transaction to be generated based on a private key of a public/private key pair associated with a user that was used to register a record on a blockchain;
provide the first transaction to be validated by a smart contract on a blockchain, wherein the smart contract is configured to automatically validate a transaction using a public key of the public/private key pair associated with the user; and
obtain a notification indicating that the user registered the record, wherein the notification is generated via the smart contract responsive to the smart contract validating the first transaction as a transaction signed using the private key associated with the user.
